(19) United States
(12) Patent Application Publication
(10) Pub. No.: US 2007/0172731 A1
(43) Pub. Date: Jul. 26, 2007

(54) PROTON-CONDUCTING POLYMER BATTERY

(76) Inventors: Tomoki NOBUTA, Sendai-shi (JP); Takashi MIZUKOSHI, Sendai-shi (JP); Naoki TAKAHASHI, Sendai-shi (JP); Tetsuya YOSHINARI, Sendai-shi (JP); Toshihiko NISHIYAMA, Sendai-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/624,579

(22) Filed: Jan. 18, 2007

(30) Foreign Application Priority Data
Jan. 20, 2006 (JP) 2006-012119

(51) Int. Cl. H01M 4/60; H01M 6/04

(52) U.S. Cl. 429/213; 429/204

(57) ABSTRACT

An objective of this invention is to provide a proton-conducting polymer battery comprising an electrode containing a proton-conducting conductive compound as an active material and an aqueous electrolytic solution, which exhibits good battery properties and higher safety and higher reliability after reflow processing. There is provided a proton-conducting polymer battery in which protons are exclusively involved in charge/discharge, comprising a cathode, an anode, a separator and an electrolytic solution; wherein: the cathode and the anode are disposed facing each other via the separator in the electrolytic solution; electrode active materials in the cathode and/or the anode are selected from π-conjugated polymers and hydroxyl-containing polymers; and the electrolytic solution is an aqueous solution comprising sulfuric acid as an electrolyte and at least one of phosphoric acid and diphosphoric acid, wherein the concentration of the contained water is 65 wt % or less, and the concentration of the sulfuric acid is 3 wt % to 35 wt %.

### BACKGROUND OF THE INVENTION

1. Field of the Invention

The present invention relates to a proton-conducting polymer battery. In particular, it relates to a battery with an aqueous electrolytic solution allowing reflow soldering.

2. Description of the Prior Art

A back-up power supply for a mobile communication device memory or the like such as a lithium secondary battery and an electric double layer capacitor has been often used where it is attached on a printed circuit board. In general, such a device is enclosed in a coin-type metal case as an outer case, to which a terminal for soldering is welded, and is frequently soldered on the printed circuit board together with a memory element. Conventionally, the soldering on a printed circuit board has been individually conducted using a soldering iron, but it has become cumbersome with an poor yield and a higher cost due to an increased interconnection density in association with a size reduction and an improved performance in an electronic device. Thus, automatic soldering known as a reflow processing has been attempted, where a cream solder is applied on a mounting area in a printed circuit board, mounted components are placed on the cream-solder applied surface and the printed circuit board equipped with the components is passed through an oven under a high-temperature atmosphere set at about 230 to 270° C. to melt the solder for soldering.

In the reflow processing, a lithium secondary battery and an electric double layer capacitor on a substrate are also exposed to an extremely high temperature of 230 to 270° C. The heat history may cause a reaction between an electrode material and an electrolytic solution, and may increase an internal resistance and an internal pressure due to an expansion of an electrolytic solution. As a result, rupture or liquid leakage of a lithium secondary battery or an electric double layer capacitor may occur, to lead to deterioration in battery properties.

As a back-up power supply, there has been proposed a proton-conducting polymer battery, in addition to the lithium secondary battery and the electric double layer capacitor. FIG. 1 is a cross-sectional view of an elementary element of a proton-conducting polymer battery. The elementary element in the proton-conducting polymer battery has a configuration where, as shown in FIG. 1, a cathode 2 and an anode 3 containing a proton-conducting compound as an active material are formed respectively on a cathode collector 1 and an anode collector 4 and these are stacked via a separator 5, and in which protons are exclusively involved as a charge carrier. Furthermore, the elementary element “a” is formed by being filled with an aqueous or non-aqueous solution containing a proton source as an electrolytic solution, and being sealed with a gasket 6.

The cathode 2 and the anode 3 are formed using a slurry prepared by adding a binder to the doped or undoped proton-conducting compound powder and a conduction auxiliary agent. The methods for producing the electrodes include: a method by placing the slurry in a mold with a desired size and pressing it to form a solid electrode; and a method by screen-printing the slurry on the collector and drying it to form a deposited electrode. The cathode 2 and the anode 3 thus formed are disposed facing each other via the separator 5.

Examples of the proton-conducting compound used as the electrode active material include π-conjugated polymers such as polyaniline, polythiophene, polypyrrole, polyacetylene, poly-p-phenylene, polyphenylene-vinylene, polyperinaphthalene, polyfuran, polythienylene, polypyridine-diyl, polyisothianaphthene, polyquinoxaline, polypyridine, polypyrimidine, polyindole, indole trimer, polyaminoanthraquinone, polyimidazole and their derivatives; hydroxyl-containing polymers, in which a quinone oxygen is converted into a hydroxyl group by conjugation, such as polyanthraquinone and polybenzoquinone; and proton-conducting polymers prepared by copolymerization of two or more monomers. These polymers can be doped to form a redox pair and can exhibit conductivity thereby. These polymers can be selected as a cathode or anode active material to appropriately adjust the difference of the redox potentials.

As the electrolytic solution are known an aqueous electrolytic solution that is an aqueous acid solution, and a non-aqueous electrolytic solution containing an organic solvent as a base solvent. For the proton-conducting compound, the former aqueous electrolytic solution has been exclusively used because it can provide a particularly high-capacity cell. As the acid, an organic acid or an inorganic acid may be used; the inorganic acids include sulfuric acid, nitric acid, hydrochloric acid, phosphoric acid, tetrafluoroboric acid, hexafluorophosphoric acid and hexafluorosilicic acid; and the organic acids include saturated monocarboxylic acids, aliphatic carboxylic acids, oxycarboxylic acids, p-toluenesulfonic acid, polyvinylsulfonic acid and lauric acid.

Examples of the proton-conducting polymer battery according to the prior art have been disclosed in Japanese Patent Application Laid-open Nos. 11-288717 and 2003-123834.

Japanese Patent Application Laid-open No. 11-288717 has disclosed a polymer battery in which electric energy is taken out from at least electron transfer accompanying a redox reaction of a compound, comprising a cathode, an anode and a solid electrolyte or a gel-like solid electrolyte, wherein: an active material as a main component for the electrode is selected from nitrogen-containing π-conjugated polymers; the solid electrolyte or the gel-like solid electrolyte comprises protons and is doped with anions having the identical or similar structure to the polymer matrix constituting the solid electrolyte or the gel-like solid electrolyte as a dopant of the cathode active material; and adsorption and desorption of the protons in the active material are exclusively involved in the electron transfer accompanying the redox reaction of the cathode and the anode active materials. It can reduce elution of the anode active material and can improve cycle properties thereof.

In the technique of Japanese Patent Application Laid-open No. 11-288717, an aqueous sulfuric acid solution can be used as an electrolytic solution, but the aqueous sulfuric acid solution alone may cause considerable battery swelling after reflow processing, leading to extreme increase in an ESR (equivalent series resistance). Therefore, a battery with good battery properties cannot be obtained. Although battery swelling may be reduced when a vapor pressure of the electrolytic solution is reduced by extremely increasing the concentration of sulfuric acid, the concentration of sulfuric acid higher than a predetermined limit accelerates deterioration of the electrode active material, leading to deterioration in the battery properties. The technique is, therefore, not effective.

Japanese Patent Application Laid-open No. 2003-123834 has disclosed an electrolytic solution comprising an water-soluble nitrogen-containing heterocyclic compound such as imidazole, triazole, pyrazole or a derivative thereof, and an electrochemical cell using the electrolytic solution. Particularly, in the electrochemical cell comprising a proton-conducting polymer as an active material, it can improve cycle properties thereof by preventing oxidation degradation of the electrode active material without reducing an apparent capacity thereof.

In the technique of Japanese Patent Application Laid-open No. 2003-123834, during reflow processing, an absolute amount of imidazole dissolved in water is reduced at least due to evaporation of the contained water, so that imidazole may be precipitated, leading to deterioration in the battery properties. Although the precipitation of imidazole would be insignificant when the amount of imidazole is considerably low, the concentration of the contained water is correspondingly increased so that battery swelling and ESR increase become prominent in reflow processing, leading to deterioration in the battery properties. The technique is, therefore, not effective.

Japanese Patent Application Laid-open Nos. 11-288717 and 2003-123834 has not described reflow processing and there are no specific descriptions or restrictions for a composition ratio or a boiling point of the electrolytic solution, heat resistance of battery-constituting members at a reflow temperature, or the like. Furthermore, there are no descriptions for additives or properties thereof which should be required for performing reflow processing.

In a proton-conducting polymer battery according to the prior art, reflow processing causes deterioration in battery properties as in a lithium secondary battery or an electric double layer capacitor, giving a battery having an unsatisfactory configuration to allow reflow processing and thus leading to many problems. Specifically, in a proton-conducting polymer battery comprising an electrode containing a proton-conducting conductive compound as an active material and an aqueous electrolytic solution, the battery is swollen and its ESR is increased after reflow processing, leading to deterioration in the battery properties.

An objective of this invention is to provide a proton-conducting polymer battery which exhibits good battery properties and higher safety and higher reliability after reflow processing.

### SUMMARY OF THE INVENTION

The present invention provides a proton-conducting polymer battery in which protons are exclusively involved in charge/discharge, comprising a cathode, an anode, a separator and an electrolytic solution; wherein: the cathode and the anode are disposed facing each other via the separator in the electrolytic solution; electrode active materials in the cathode and/or the anode are selected from π-conjugated polymers and hydroxyl-containing polymers; and the electrolytic solution is an aqueous solution comprising sulfuric acid as an electrolyte and at least one of phosphoric acid and diphosphoric acid, wherein the concentration of the contained water is 65 wt % or less, and the concentration of the sulfuric acid is 3 wt % to 35 wt %; and desirably the electrolytic solution comprises a water-soluble imidazole compound and/or a triazole compound.

In the proton-conducting polymer battery of the present invention, the electrolytic solution contains at least one of phosphoric acid and diphosphoric acid, allowing reflow processing and giving good battery properties because of the following three effects.

First, reduction in an absolute amount of water contained in the electrolytic solution and addition of the phosphoric acid compound result in solvation and increase in a boiling point, which can reduce expansion of the electrolytic solution during reflow processing and thus reduce increase in an internal pressure of the battery, resulting in reduction in battery swelling. These can minimalize increase of a resistance component such as a contact resistance. Furthermore, it results in prevention of battery rupture or liquid leaking, giving a safe battery.

Secondly, when heated, two molecules of phosphoric acid loses one molecule of water at a temperature of about 150° C., and are transformed into diphosphoric acid at 200° C. or higher and further into metaphosphoric acid at 300° C. or higher, and are not decomposed in a reflow temperature range of 230° C. to 270° C. It is further known that diphosphoric acid is transformed into two molecules of phosphoric acid by adding water at an arbitrary temperature. Therefore, during reflow processing, only increase or decrease of water molecules occurs, and thus ion species constituting the electrolytic solution are unchanged, so that there occur no further side reactions such as that between the electrolytic solution and the electrode after the reflow processing.

Thirdly, each of phosphorous acid and diphosphoric acid is a weak acid, which has an ionization degree significantly smaller than 1, causing less increase of the proton concentration than that when the electrolytic solution contains a strong acid, which has an ionization degree near 1, with high concentration or another kind of strong acid material is added, resulting in prevention of deterioration of the electrode active material.

### BRIEF DESCRIPTION OF THE DRAWINGS

FIG. 1 is a cross-sectional view of an elementary element in a proton-conducting polymer battery;

FIG. 2 is a cross-sectional view of a proton-conducting polymer battery with lead terminals; and

FIG. 3 is a cross-sectional view of a coin-type proton-conducting polymer battery.

### DETAILED DESCRIPTION OF PREFERRED EMBODIMENTS

There will be described embodiments of this invention with reference to the drawings.

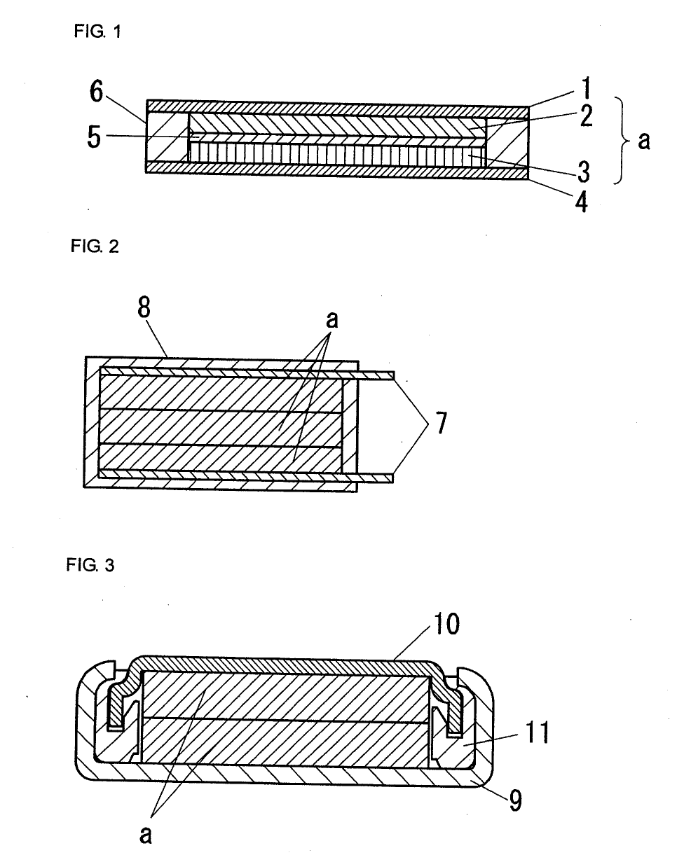

FIG. 1 is a cross-sectional view of an elementary element in a proton-conducting polymer battery; FIG. 2 is a cross-sectional view of a proton-conducting polymer battery with lead terminals; and FIG. 3 is a cross-sectional view of a coin-type proton-conducting polymer battery.

Hereinafter, there will be described a configuration and a preparation method for the proton-conducting polymer battery.

As shown in FIG. 1, an elementary element “a” in a proton-conducting polymer battery has a configuration where a cathode 2 and an anode 3 containing a proton-conducting compound as an active material are formed respectively on a cathode collector 1 and an anode collector 4 and these are stacked via a separator 5, and in which protons are exclusively involved as a charge carrier. Furthermore, the elementary element “a” is prepared by being filled with an aqueous or non-aqueous solution containing a proton source as an electrolytic solution, and being sealed with a gasket 6. As shown in FIG. 2, after stacking an arbitrary number of the elementary elements “a”, a lead terminal 7 made of metal is placed in each of the cathode side and the anode side, and the stacked elements with the lead terminals are enclosed in an outer case 8 to prepare a proton-conducting polymer battery with lead terminals. Alternatively, as shown in FIG. 3, the stacked elements is enclosed in a casing body consisting of a case 9, a cap 10 and a packing 11 to prepare a coin-type proton-conducting polymer battery. There are no limitations to a shape of the casing.

The battery of the present invention can preferably operate such that a redox reaction in charge/discharge involves only protons as a charge carrier. Specifically, the battery containing an electrolyte having a proton source can preferably operate such that electron transfer in the redox reaction involves only adsorption and desorption of protons in the electrode active material.

The active materials for the cathode 2 and the anode 3 may be selected from, but not limited to, compounds capable of being involved in a redox reaction in a solution containing a proton source and/or activated carbon. Examples of the active material include π-conjugated polymers such as polyaniline, polythiophene, polypyrrole, polyacetylene, poly-p-phenylene, polyphenylene-vinylene, polyperinaphthalene, polyfuran, polythienylene, polypyridine-diyl, polyisothianaphthene, polyquinoxaline, polypyridine, polypyrimidine, polyindole, indole trimer, polyaminoanthraquinone, polyimidazole and their derivatives; hydroxyl-containing polymers, in which a quinone oxygen is converted into a hydroxyl group by conjugation, such as polyanthraquinone and polybenzoquinone; and proton-conducting polymers prepared by copolymerization of two or more monomers. There will be detailed a proton-conducting polymer battery comprising an indole derivative trimer represented by formula 1 as the active material of the cathode 2 and a polyphenylquinoxaline derivative represented by formula 2 as the active material of the anode 3.

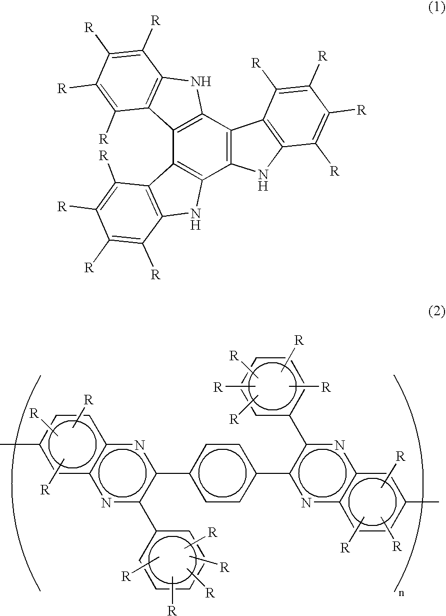

In formulas 1 and 2, Rs independently represent hydrogen atom, hydroxyl group, carboxyl group, nitro group, phenyl group, vinyl group, a halogen atom, acetyl group, acyl group, cyano group, amino group, trifluoromethyl group, sulfonyl group, sulfonic acid group, trifluoromethylthio group, carboxylate group, sulfonate group, alkoxyl group, alkylthio group, arylthio group, an alkyl group having 1 to 20 carbon atoms optionally substituted with any of these substituent groups, an aryl group having 2 to 20 carbon atoms optionally substituted with any of these substituent groups, an aryl group having 2 to 20 carbon atoms further having a heteroatom, or a group having heterocyclic structure.

The term “independently” as used herein means that all of the repeating units may be the same or different and, in formula 2, that they are independent in each of polymer structures.

These electrode active materials are desirably free of impurities as much as possible for avoiding an undesirable reaction between the impurities contained and the electrolytic solution by a heat for reflow, and they preferably have a purity of 95% or higher.

The cathode 2 and the anode 3 are prepared as described below. An conduction auxiliary agent such as VGCF (manufactured by Showa Denko K.K.) which is fibrous carbon or Ketjen Black EC600JD (manufactured by Ketjen Black International) which is particulate carbon is mixed with an electrode active material so that the amount of the conduction auxiliary agent is 1 to 50 parts by weight, preferably 10 to 30 parts by weight, per 100 parts by weight of the electrode active material. The powdery mixture is pressed at room temperature to 400° C., preferably at 100 to 300° C. Alternatively, the mixture is dispersed in an arbitrary organic solvent or water to prepare a slurry, to which can be, if necessary, added a binder in 1 to 20 parts by weight, preferably 5 to 10 parts by weight, per 100 parts by weight of the active material. The slurry is screen-printed on a conductive substrate and then dried, to prepare the electrode. A binder used is preferably, but not limited to, polyvinylidene fluoride (PVdF) or polytetrafluoroethylene (PTFE). There are no particular limitations to its molecular weight as long as it can be dissolved in a solvent used.

The separator 5 may be made of any material which is acid-resistant, capable of insulating between the cathode and the anode, ion-permeable, and resistant to deformation and degeneration under a reflow temperature of 230 to 270° C. Although depending on the reflow conditions, which include a peak upper limit temperature, a reflow time and the number of reflow, for example, glass fiber or PTFE is preferable because of the good heat resistance. Under a certain reflow condition, a pulp paper or the like may be used. The thickness is preferably, but not limited to, 10 to 200 μm, more preferably 10 to 100 μm.

The cathode collector 1 and the anode collector 4 may be made of any material which is acid-resistant, conductive, and resistant to deformation and degeneration under a reflow temperature of 230 to 270° C. If an insulating resin is used as a main component of the collector, a carbon material such as carbon black may be mixed to the resin for endowing conductivity. In particular, it is desirable to select a less gas-permeable material for preventing leaking of volatile components in the internal electrolytic solution by a heat for reflow. The collector is most preferably made of a material containing a butyl rubber as a main component. The thickness is preferably, but not limited to, 30 to 200 μm, more preferably 60 to 130 μm.

The gasket 6 may be made of any material which is acid-resistant, insulating, and resistant to deformation and degeneration under a reflow temperature of 230 to 270° C. In particular, using a gasket made of a resin containing the same component as the collector may facilitate a sealing/adhering process with effective sealing. Thus, the gasket is preferably made of a material containing a butyl rubber as a main component.

The outer case 8 used for a proton-conducting polymer battery with lead terminals may be made of any material which is resistant to deformation and degeneration under a reflow temperature of 230 to 270° C. The material is preferably selected from metals such as stainless steel, iron and aluminum; and heat-resistant resins such as a polyphenylene sulfide (PPS), a polyether ether ketone (PEEK), a tetrafluoroethylene-perfluoroalkyl vinyl ether copolymer (PFA), a liquid crystal polymer (LCP), 6T Nylon and 9T Nylon.

The electrolytic solution may be any solution containing a proton source, but must be selected from relatively stable materials which are not decomposed under a reflow temperature of 230 to 270° C. In this invention, an aqueous solution which contains sulfuric acid as an electrolyte and at least one of phosphoric acid and diphosphoric is used as the electrolytic solution.

A concentration of sulfuric acid in the electrolytic solution is preferably 3 wt % to 35 wt %, more preferably 10 wt % to 25 wt % in the light of conductivity and preventing deterioration of the active material. If the concentration of sulfuric acid is increased above the optimum range, a vapor pressure of the electrolytic solution is reduced to prevent rupture, liquid leaking and battery swelling while deterioration (deterioration by oxidation) of the electrode active material is accelerated, consequently leading to deterioration in the battery properties.

A concentration of water contained in the electrolytic solution is desirably reduced by adding additives, preferably adjusted to 65 wt % or less in the light of preventing expansion attributed to the electrolytic solution during reflow processing as much as possible.

The additive may be desirably selected from compounds satisfying the following three requirements in order to avoid deterioration in the battery properties after reflow processing. First, the compounds should not be decomposed under a reflow temperature of 230 to 270° C. Secondly, in the compounds, dissociation of ion components other than the components constituting the electrolytic solution before reflow processing should be minimized, which are generated by a heat history of the reflow processing. Thirdly, increase of the concentration of proton in the electrolytic solution should be minimized, which are generated by addition of the compound and heat history of the reflow processing.

In this invention, at least one of phosphoric acid and diphosphoric acid, which is a weak acid, is used as the additive. Further, a nitrogen-containing heterocyclic compound such as imidazole and triazole, which is basic, can be combined as the additive.

A concentration of at least one of phosphoric acid and diphosphoric acid in the electrolytic solution is preferably 3 wt % to 30 wt %, more preferably 3 wt % to 15 wt %. The concentration over the range is undesirable because the viscosity of the electrolytic solution is so increased to deteriorate charge/discharge properties. Thus, since phosphoric acid or diphosphoric acid makes the electrolytic solution more viscous and less conductive than an aqueous solution of sulfuric acid. Thus, it is undesirable, for example, to use it as an electrolytic solvent, but it is effective to use it as the additive.

The nitrogen-containing compound such as imidazole has the properties describe above and does not deteriorate battery properties when being added. As the additive, it may be, therefore, advantageously combined with at least one of phosphoric acid and diphosphoric acid because it may increase flexibility for designing the composition in terms of adjustment of the concentrations of sulfuric acid, phosphoric acid or diphosphoric acid, and contained water in the electrolytic solution. There are no limitations to the amount used as long as it can be dissolved in the electrolytic solution, but an excessive amount may lead to its precipitation after reflow processing or at a low temperature.

### EXAMPLES

There will be specifically described examples of the present invention, but the invention is not limited to only these examples.

### Example 1

Methyl indole-6-carboxylate trimer was selected as a cathode active material; VGCF, which is a fibrous carbon, was selected as a conduction auxiliary agent; and PTFE was selected as a binder. A slurry was prepared from these compounds with a weight ratio of 69:23:8, respectively, which was formed into an electrode to provide a cathode with a diameter of 2.1 mm and a thickness of 200 μm.

In terms of an anode, polyphenylquinoxaline selected as an anode active material was stirred and blended by a blender with Ketjen Black EC600JD as a conduction auxiliary agent in a weight ratio of 75:25, respectively, which was formed by pressing to provide an anode with a diameter of 2.3 mm and a thickness of 200 μm.

A PTFE film with a thickness of 50 μm was used as a separator. The cathode and the anode described above were stacked such that their electrode surfaces face each other via the separator. After impregnation of an electrolytic solution, the assemble was vulcanization-sealed using a butyl rubber sheet with a thickness of 120 μm as a collector, which had been made conductive, and a butyl rubber gasket, to provide an elementary element. Two elementary elements are electrically serially stacked and enclosed in an outer case for a button battery with a diameter of 4.8 mm (case and cap material: stainless steel, packing material: PEEK), to provide a coin-type proton-conducting battery having the configuration shown in FIG. 3. The electrolytic solution had the composition shown in Table 1, in which sulfuric acid is 24.0 wt %, water is 59.0 wt %; and phosphoric acid is 17.0 wt %.

For this battery, a battery swelling, an ESR (equivalent series resistance) and a discharge capacity were measured after reflow processing under the conditions below. Table 1 shows the composition of the electrolytic solution and the results of reflow properties. The composition of the electrolytic solution is expressed a weight ratio of each material when the total is 100. The reflow processing conditions were as follows; the sample was kept at 160° C. for 120 sec and then heated to 260° C. Here, it was exposed to a temperature of 200° C. or higher for 80 sec. A capacity was measured under the conditions: charging (CCCV) at 250 μA-2.5 V and at 25° C. for 10 hours and discharging (CC) at 20 μA. The result was expressed as a ratio of change of the discharge capacity after reflow processing to that before the reflow processing, which was calculated by the following formula:

(discharge capacity after reflow processing)/(discharge capacity before reflow processing)×100%.

The battery swelling after the reflow processing was 76 μm; the ESR to that before the reflow processing was 1.6 folds; and the discharge capacity to that before the reflow processing was 93%.

### Examples 2 to 11 and Comparative Examples 1 to 4

In Examples 2 to 10 and Comparative Examples 1 to 4, batteries were provided as in Example 1, using electrolytic solutions with the compositions described in Table 1, and were evaluated for their reflow properties. In terms of the compositions of the electrolytic solutions, the electrolytic solutions of Examples 2 to 4 contained phosphoric acid; the electrolytic solution of Example 5 contained phosphoric acid and diphosphoric acid; and the electrolytic solutions of Examples 6 to 10 contained phosphoric acid and 1H-imidazole. In Example 11, a battery was prepared as in Example 4, except that activated carbon was used as an electrode active material in a cathode, and was evaluated for its reflow properties.

TABLE 1

| | | | | | | | | Reflow properties | | |
|---|---|---|---|---|---|---|---|---|---|---|
| | | | | | | | | Battery | | |
| | | | Composition of electrolytic solution (wt %) | | | | | swelling | ESR to that | Capacity to that |
| | Electrode active material | | Sulfuric | | Phosphoric | Diphosphoric | 1H- | after reflow | before reflow | before reflow |
| Level | Cathode | Anode | acid | Water | acid | acid | imidazole | (mm) | (folds) | (%) |
| Ex. 1 | Methyl indole- | Polyphenyl- | 24.0 | 59.0 | 17.0 | 0 | 0 | 0.076 | 1.6 | 93 |
| Ex. 2 | 6-carboxylate | quinoxaline | 20.0 | 51.7 | 28.3 | 0 | 0 | 0.056 | 1.3 | 88 |
| Ex. 3 | trimer | | 28.6 | 67.4 | 4.0 | 0 | 0 | 0.124 | 3.8 | 71 |
| Ex. 4 | | | 33.3 | 52.5 | 14.2 | 0 | 0 | 0.051 | 2.3 | 82 |
| Ex. 5 | | | 25.0 | 59.6 | 7.1 | 8.3 | 0 | 0.071 | 1.5 | 94 |
| Ex. 6 | | | 15.2 | 63.1 | 14.2 | 0 | 7.6 | 0.068 | 1.5 | 95 |
| Ex. 7 | | | 14.0 | 57.3 | 7.7 | 0 | 21.0 | 0.062 | 1.4 | 97 |
| Ex. 8 | | | 12.1 | 49.8 | 7.7 | 0 | 30.3 | 0.052 | 1.2 | 99 |
| Ex. 9 | | | 6.3 | 57.9 | 4.0 | 0 | 31.7 | 0.072 | 1.5 | 94 |
| Ex. 10 | | | 3.2 | 64.4 | 19.6 | 0 | 12.8 | 0.092 | 2.1 | 84 |
| Ex. 11 | Activated | | 33.3 | 52.5 | 14.2 | 0 | 0 | 0.052 | 1.3 | 96 |
| | carbon | | | | | | | | | |
| Comp. | Methyl indole- | Polyphenyl- | 30.0 | 70.0 | 0 | 0 | 0 | 0.168 | 12.4 | 32 |
| Ex. 1 | 6-carboxylate | quinoxaline | | | | | | | | |
| Comp. | trimer | | 10.0 | 90.0 | 0 | 0 | 0 | Ruptured | Not | Not |
| Ex. 2 | | | | | | | | | measurable | measurable |
| Comp. | | | 40.0 | 60.0 | 0 | 0 | 0 | 0.075 | 14.7 | 5 |
| Ex. 3 | | | | | | | | | | |
| Comp. | | | 20.0 | 46.7 | 0 | 0 | 33.3 | 0.068 | 1.9 | Crystal |
| Ex. 4 | | | | | | | | | | precipitation |

The results in Table 1 indicate that addition of phosphoric acid and/or diphosphoric acid can reduce the battery swelling after reflow processing and prevent increase of the ESR, to give good discharge properties.

In Example 2 in comparison with Example 1, the ESR increase was smaller, while the capacity reduction was larger. These would be due to deterioration in the discharge property caused by increase in viscosity of the electrolytic solution to which a large amount of phosphoric acid was added. However, the capacity after reflow processing was maintained in 80% or more, indicating a good reflow property.

In Example 3 in comparison with Example 1, the battery swelling and the ESR increase were larger, while the capacity reduction was larger. These would be mainly due to influence of the amount of the contained water. However, rupture of the battery was prevented and battery function was maintained.

In Example 4 in comparison with Example 1, the battery swelling was smaller, while the ESR increase and the capacity reduction were larger. These would be due to deterioration of the electrode active material caused by a high concentration of sulfuric acid. However, the capacity after reflow processing was maintained in 80% or more, indicating a good reflow property. When using another material such as activated carbon as a cathode as in Example 11, a degree of deterioration of the active material varied, giving better results than those in Example 4.

It was found that Examples 5 to 10 gave substantially comparable results to Example 1, indicating that various additives can be combined. Furthermore, comparing the cases where the concentrations of the contained water are substantially equal (Examples 6 and 10, and Examples 7 and 9), it is found that the composition of sulfuric acid, phosphoric acid and imidazole can be appropriately adjusted to obtain better battery properties than the case where only phosphoric acid was added as an additive. On the other hand, when adding only 1H-imidazole as an additive (Comparable Example 4), crystal precipitation was observed in the inside of the battery after reflow processing, implying deterioration in battery properties in terms of long-term reliability. It was also found that phosphoric acid added to the electrolytic solution was effective in prevention such precipitation. It was probably because of a neutralization reaction (H coordination to N-position) between 1H-imidazole as a basic compound and phosphoric acid as an acidic compound; specifically because isolation of 1H-imidazole is more difficult in comparison with hydrogen bonding with water molecules. Although 1H-imidazole was used in this example, a triazole compound may be similarly effective.

As described above, it has been found that the optimum concentration of sulfuric acid and contained water, and the optimum additive selection for the electrolytic solution according to this invention can give a battery with a good reflow property. When the concentration of the contained water is higher than 65 wt %, improper expansion during reflow processing occurs by water in the electrolytic solution. When the concentration of the sulfuric acid is higher than 35 wt %, deterioration of the electrode active material may occur. When the concentration of the sulfuric acid is lower than 3 wt %, conductivity of the electrolytic solution is inadequate.

1. A proton-conducting polymer battery in which protons are exclusively involved in charge/discharge, comprising a cathode, an anode, a separator and an electrolytic solution; wherein:
the cathode and the anode are disposed facing each other via the separator in the electrolytic solution;
electrode active materials in the cathode and/or the anode are selected from π-conjugated polymers and hydroxyl-containing polymers; and
the electrolytic solution is an aqueous solution comprising sulfuric acid as an electrolyte and at least one of phosphoric acid and diphosphoric acid, wherein the concentration of the contained water is 65 wt % or less, and the concentration of the sulfuric acid is 3 wt % to 35 wt %.

2. The proton-conducting polymer battery as claimed in claim 1, wherein the electrolytic solution comprises a water-soluble imidazole compound and/or a triazole compound

3. A proton-conducting polymer battery in which protons are exclusively involved in charge/discharge, comprising:
a cathode and an anode, at least one of which contains an electrode active material selected from π-conjugated polymers and hydroxyl-containing polymers;
a separator interposed between the cathode and the anode; and
an electrolytic solution in which the cathode, the anode, and the separator are placed, said electrolytic solution having reflow-processing stability and being an aqueous solution consisting essentially of:
(i) sulfuric acid as an electrolyte;
(ii) at least one of phosphoric acid or diphosphoric acid;
(iii) water; and
(iv) optionally a water-soluble imidazole compound and/or a triazole compound.

4. The proton-conducting polymer battery as claimed in claim 3, wherein the electrolytic solution contains the sulfuric acid in an amount of 3 wt % to 35 wt % and the water in an amount of 65 wt % or less.

5. The proton-conducting polymer battery as claimed in claim 3, wherein the electrolytic solution contains the water-soluble imidazole compound and/or the triazole compound.
